(19) United States
(12) Patent Application Publication
(10) Pub. No.: US 2026/0324705 A1
(43) Pub. Date: Oct. 22, 2026

(54) FOOD COMPOSITION COMPRISING ONE OR A PLURALITY OF COATED FOOD PARTICLES

(71) Applicant: SOCIÉTÉ DES PRODUITS NESTLÉ S.A., Vevey (CH)

(72) Inventors: Linda BRÜTSCH, Lausanne (CH); Vincent Daniel Maurice MEUNIER, Epalinges (CH); Delphine PASCHE, Démoret (CH)

(21) Appl. No.: 19/103,435

(22) PCT Filed: Aug. 24, 2023
(86) PCT No.: PCT/EP2023/073212

§ 371 Date: Feb. 12, 2025

(30) Foreign Application Priority Data
Aug. 24, 2022 (EP) 22191957.4

(51) Int. Cl. A23P 20/10; A23P 10/30; A23P 10/40; A23P 20/20

(52) U.S. Cl. CPC A23P 20/11; A23P 10/30; A23P 10/40; A23P 20/20

(57) ABSTRACT

A method of making a food composition comprising one or a plurality of coated food particles is disclosed. The method comprises a step of providing one or a plurality of food particles. It further comprises a step of coating each of the food particle with carbohydrate. This results in a food composition comprising one or a plurality of food particles coated with crystalline carbohydrate layer. The crystalline carbohydrate layer comprises at least 95% crystalline carbohydrate particles and has a closed porosity lower than 10%. A food composition comprising one or a plurality of coated food particles and a coated food particle are also disclosed.

### CROSS REFERENCE TO RELATED APPLICATIONS

The present application is a National Stage of International Application No. PCT/EP2023/073212 filed Aug. 24, 2023, which claims priority to European Patent Application No. 22191957.4 filed Aug. 24, 2022, the entire contents of which are incorporated herein by reference.

### TECHNICAL FIELD

The present invention relates generally to the field of coating of food particles and the field of food composition comprising one or several food particles. For example, the present invention relates a method of making a food composition comprising one or a plurality of coated food particles. It also relates to coated food particle and food composition comprising one or more of such a coated food particle.

### BACKGROUND OF THE INVENTION

Food products, including food powders, are generally stored in thermoplastic or metallic packaging to preserve their quality over the shelf life. In particular, the packaging forms a barrier between the food product and the external environment so that the organoleptic, nutritional, functional, stability and hygienic properties of the food product remain acceptable until consumption.

For environmental considerations, there is an ongoing switch towards more sustainable packaging materials which are recyclable and/or biodegradable. An example of sustainable packaging materials option is paper. However, the sustainable packaging materials, such as paper, have generally weaker barrier properties, are more fragile to mechanical constraints and are also more porous to the external environment than traditional packaging. Hence, the volatile compounds, e.g. aroma, of the food products tend to be released easily in the atmosphere over shelf life resulting in lower sensory properties. In addition, the food products are also more exposed to mechanical constraints but also to physico-chemical elements from the external environment that negatively affect the stability of the food products, e.g. temperature, moisture, oxygen or light. This results in food products that do not preserve the organoleptic, nutritional, functional, stability and hygienic properties along their traditional shelf life.

This is in particular the case for food powders or other moisture-sensitive food products, e.g. freeze-dried fruits. As the sustainable packaging materials are more porous to the external environment, the moisture uptake of the food powders and moisture-sensitive food products is accelerated. As a result, the food powders or other moisture-sensitive food products may for example cake, or even spoil early, before the end of the traditional shelf life.

As alternative to sustainable packaging materials, the use of packaging-free options is also considered. For example, the selling of food products, in particular food powders, in bulk is one of these options. However, the abovementioned challenges are accentuated in that case.

Hence, there remains a need to provide a food composition, for example food powder composition or moisture-sensitive food composition, that preserves its overall quality and properties and exhibit improved stability along the shelf life, even when exposed to external environment, including important moisture or elevated temperatures. It would be desirable that the food composition keeps good reconstitution properties when added in aqueous liquid.

Any reference to prior art documents in this specification is not to be considered an admission that such prior art is widely known or forms part of the common general knowledge in the field.

### SUMMARY OF THE INVENTION

The object of the present invention is to improve the state of the art, and in particular to provide a method of making a food composition and coated food particle that overcome the problems of the prior art and addresses the needs described above, or at least to provide a useful alternative.

The inventors were surprised to see that the object of the present invention could be achieved by the subject matter of the independent claims. The dependent claims further develop the idea of the present invention.

Accordingly, a first aspect of the invention proposes a method of making a food composition comprising one or a plurality of coated food particles, said method comprising the steps of:
a) providing one or a plurality of food particles,
b) coating each of the food particle of step a) with a carbohydrate to form a food composition comprising one or a plurality of coated food particles, said one or plurality coated food particles are food particles coated with crystalline carbohydrate layer, wherein the crystalline carbohydrate layer comprises at least 95% crystalline carbohydrate and has a closed porosity lower than 10%.

A second aspect of the invention proposes a coated food particle which comprises a food particle which is coated with crystalline carbohydrate layer, wherein the crystalline carbohydrate layer comprises at least 95% crystalline carbohydrate and has a closed porosity lower than 10%. In a particular embodiment, the crystalline carbohydrate layer comprises at least 95% crystalline carbohydrate particles.

A third aspect of the invention one or a plurality of coated food particles according to the second aspect of the invention.

It has been discovered that the coating of food composition, for example food powder composition or moisture-sensitive food composition with crystalline carbohydrate layer provides good barrier properties. The stability of coated food composition is therefore enhanced over shelf life even when exposed to external environment, including moisture or elevated temperatures. The coated food composition keeps good reconstitution properties. Due to good barrier properties, the crystalline carbohydrate layer may be used for encapsulation of sensitive food-grade ingredients, such as flavouring agent, vitamins, probiotics, food-grade active ingredients.

These and other aspects, features and advantages of the invention will become more apparent to those skilled in the art from the detailed description of embodiments of the invention, in connection with the attached drawings.

### BRIEF DESCRIPTION OF THE DRAWINGS

FIG. 1 shows the moisture pick up of samples 1-5 of example 6 (dm=dry matter).

FIG. 2 shows caking and flowability after heat treatment at 60° C. for 7 days of a reference 3-in-1 coffee mix powder without crystalline coating (left) and of a 3-in-1 coffee powder with a crystalline coating according to the invention (right).

FIG. 3 shows photographs of the granules after different processing step: a corresponds to spheronized coffee granules before any coating (sample 2 of example 6), b corresponds to spheronized coffee granules coated with creamer obtained after coating with a creamer powder via spheronization (sample 3 of example 6) and c corresponds to creamer-coated coffee granules which are further coated with crystalline sucrose (sample 4 of example 6).

FIG. 4 is a Scanning Electron Microscopy (SEM) image showing a cross-sectional view of a granule of sample 4 of example 6. x shows the core of the granules which is coffee granules, y shows the creamer coating and z shows the crystalline sucrose coating.

FIG. 5 is a photograph showing the cross-sectional view of a granule of sample 4 of example 6. x shows the core of the granules which is coffee granules, y shows the creamer coating and z shows the crystalline sucrose coating.

FIG. 6 represents Water Vapour Transmission Rate (WVTR) (in g/m²/day) of crystalline sucrose coating at a temperature of 23° C. and at a relative humidity of 85% as a function of the coating thickness (in μm). A logarithmic trendline was plotted. (cf. example 18).

FIG. 7 is a SEM images showing the surface of crystalline sucrose coating that was applied on paper UPM 62.

FIG. 8 shows SEM images: the SEM image on the left shows a cross-sectional view of plurality of cocoa powder particles coated with heterogenous crystalline sucrose layer according to example 19. The circles show areas which are not cover by the coating or shows holes. The SEM image on the right shows an external view of a cocoa powder particle coated with heterogenous crystalline sucrose layer according to example 19. The circle shows holes.

### DETAILED DESCRIPTION OF THE INVENTION

As used in the specification, the words “comprise”, “comprising” and the like are to be construed in an inclusive sense, that is to say, in the sense of “including, but not limited to”, as opposed to an exclusive or exhaustive sense.

As used in the specification, the singular forms “a”, “an”, and “the” include plural referents unless the context clearly dictates otherwise.

Unless noted otherwise, all percentages in the specification refer to weight percent, where applicable.

Unless defined otherwise, all technical and scientific terms have and should be given the same meaning as commonly understood by one of ordinary skill in the art to which this invention belongs.

In the context of the invention, the term “food particles” refers to particles which are edible.

In the context of the invention, the term “shaped food particles” refers to particles of food having a predefined shape.

In the context of the invention, the term “shaping” refers to the processing of a food particle or a plurality of food particles together to provide a food particle with a predefined shape.

In the context of the invention, the term “plant-based milk beverage analogue” refers to a beverage which comprises ingredients of plant origin, which is free from dairy ingredients, and which mimics the texture and the appearance of a milk beverage.

In the context of the invention, the term “crystalline carbohydrate” refers to carbohydrate which is characterised by having a three-dimensional long-range order of atomic positions. The atoms of crystals are arranged in a translationally periodic array.

Crystalline solids are characterised by having one melting point, at which the transition between solid and liquid state occurs (compared to Tg for amorphous solids). They dissolve once a critical relative humidity is reached, e.g. 83-85% for sucrose. Below this value, only negligible quantities of water can be found in crystals (stored as crystal water in the crystalline matrix).

In the context of the invention, the term “amorphous carbohydrate” or “non-crystalline carbohydrate” is a carbohydrate that possesses a non-periodic array with highly-disordered atomic position. In other words, an amorphous carbohydrate is a carbohydrate which is not a crystalline carbohydrate. The amorphous carbohydrate may be a glassy or rubbery solid.

In the context of the invention, the term “aroma” refers to flavour and/or fragrance, preferably flavour and/or fragrance which are volatile.

In the context of the invention, the term “protective barrier” refers to a layer that limits, preferably prevents, the contact or flux between the food particles and the external environment surrounding such a layer (or protective barrier). In particular, it may limit, preferably may prevent, the contact or flux between the food particles and the moisture, external gas (e.g. oxygen), light (e.g. UVs), mechanical constraints and/or any other external elements or factors that may negatively impact the properties, e.g. sensory, nutritional, stability, functional and/or microbiological properties, of the food particles. It may also limit, preferably prevent, the release of volatile compounds, e.g. aroma, from the food particles in the environment surrounding the layer (or protective barrier).

In the context of the invention, the term “surfactant” means compounds that are surface active. Surfactant molecules typically have a hydrophilic portion (e.g., one or more head groups) and a hydrophobic (or lipophilic) portion (e.g., one or more tails).

In the context of the invention, the term “food-grade active ingredient” refers to an ingredient which is edible and showing health impact and/or biological activity, in particular pharmaceutical or cosmetic activities, when ingested orally by a subject, preferably a pet or human.

In the context of the invention, the term “flavouring agent” refers to an ingredient or mixture of ingredients that provides a flavour. It may also provide fragrance.

In a first aspect, the invention relates to a method of making a food composition comprising one or a plurality of coated food particles. Preferably, the food composition is a coffee mix (for example a 2-in-1 or 3-in-1 coffee mix), infant formula, nutritional composition, food supplement, powdered beverage, or a moisture sensitive food composition. A 3-in-1 coffee mix is a mixture of soluble coffee powder, creamer or milk powder and carbohydrate, preferably sucrose. A 2-in-1 coffee mix is a mixture of soluble coffee powder and carbohydrate, preferably sucrose. For example, the powdered beverage may be powdered milk beverage, powdered cocoa beverage, powdered coffee beverage, powdered tea beverage, powdered malt beverage, powdered fruit beverage, protein shake or powdered plant-based milk beverage analogue. For example, the moisture sensitive food composition may be vitamin, mineral, flavouring agent, fruit powders, including freeze-dried fruits, cereals, probiotics, protein, food-grade active ingredients or a mixture thereof. In a preferred embodiment, the moisture sensitive food composition is selected from the list consisting of flavouring agent, vitamin, mineral, protein, probiotics, food-grade active ingredients or a mixture thereof.

The method comprises a step a) of providing one or a plurality of food particles. If there is a plurality of food particles, the food particles may have same or different size and/or shape. The food particle may also be originated from the same food product or from different food product. The food particle(s) may be agglomerated powder, non-agglomerated powder, compacted powder, granulated powder, spheronized powder, pelletized powder, freeze-dried powder, freeze-dried pieces, extruded food products, fruits, vegetables, flavouring agents, probiotics, vitamins, minerals, food-grade active ingredients or a mixture thereof. Examples of extruded food products include cereals. Preferably, the food particle(s) is/are powder, in particular powder selected from the list consisting of agglomerated powder, non-agglomerated, compacted powder, granulated powder, spheronized powder, pelletized powder, freeze-dried powder or a mixture thereof. More preferably, the powder is selected from the list consisting of agglomerated powder, spheronized powder, compacted powder or a mixture thereof. In an embodiment, the food particles are not cereal pieces or corn flakes.

The powder may be any type of food powder. Non-exhaustive examples of food powder include coffee powder, milk powder, creamer powder, cocoa powder, fruit powder, vegetable in powder, flavouring agents in powder form, probiotics in powder form, vitamins in powder form, minerals in powder form, food-grade active ingredients in powder form.

In an embodiment, the one or plurality of food particles are one or a plurality of shaped food particles and wherein the one or plurality of coated food particles are one or a plurality of coated shaped food particles. The one or plurality of shaped food particles may be obtained by shaping one or plurality of food particles and the shaping is performed using a grinder, milling device, compacter, extruder, pelletizer, tabletting machine or spheronizer. In other words, the shaped food particles may be obtained by shaping a single particle into a particle having the targeted shape. It may also be obtained by shaping a plurality of particles together to form a bigger particle having the targeted shape, said bigger particle consisting of such a plurality of particles that has been shaped together.

In an embodiment, the one or plurality of food particles may comprise at least two layers. In particular, the different layers have different composition or are of different nature. For example, one layer may be coffee layer while the other layer is a dairy layer, in particular creamer layer. In an embodiment, at least one layer may be an inner layer, and at least one layer may be an outer layer which covers part or the entirety of the inner layer. For example, the inner layer may be a coffee layer while the outer layer is a dairy layer, in particular creamer layer.

The particle size of the food particles should not be too small to avoid improper and inhomogeneous coating of the food particles. It is also important that the food particles is not too small to limit the carbohydrate intake upon consumption. Indeed, the smaller the food particles is, the higher amount of crystalline carbohydrate is needed for the coating step. In particular, the D[3,2] particle size of the one or plurality of food particles may be of at least 0.2 mm, preferably at least 1 mm, most preferably at least 2 mm. The maximum size of the food particles may be defined according to the serving and the application. In a preferred embodiment, the D[3,2] particle size of the one or plurality of food particles may be of 0.2 mm to 20 mm, preferably 1 mm to 20 mm, more preferably 2 mm to 20 mm. The food particle size may be measured by using a particle size analyser, in particular CamSizer XT (Retsch Technology GmbH, Germany). The D[3,2] particle size is the mean of the particle size distribution sometimes referred to as the surface area mean or Sauter Mean Diameter.

In some embodiment, the food particle(s) may be free from the carbohydrate(s) present in the crystalline carbohydrate layer. In this embodiment, the food particle(s) may comprise carbohydrate(s), said carbohydrate(s) being different from the carbohydrate(s) present in the crystalline carbohydrate layer. This limits the carbohydrate content in the final food composition. In particular, a given quantity of part or all carbohydrate(s) may be removed from the food particle recipe and the same given quantity of this/these carbohydrate(s) may be used to prepare the coating, i.e. crystalline carbohydrate layer. In this way, good barrier properties may be provided to the final food composition while retaining the same amount of carbohydrate in said composition. Especially, no additional amount of carbohydrate is added to prepare the crystalline carbohydrate layer(s) in the food composition.

The method further comprises a step b) of coating each of the food particle of step a) with carbohydrate to form a food composition comprising one or a plurality of coated food particles. Said one or plurality coated food particles are food particles coated with crystalline carbohydrate layer.

The carbohydrate may be any carbohydrate known to the person skilled in the art. In particular, the carbohydrate used in the coating step b) may be selected from the list consisting of lactose, sucrose, fructose, maltose, glucose, galactose, polyol, allulose, dextrose and mixtures thereof. Preferably, the carbohydrate used in the coating step b) is sucrose and/or lactose, more preferably sucrose.

In an embodiment, the step b) of coating is performed with carbohydrate which is:
i) at least one solid crystalline carbohydrate, or,
ii) at least one solid crystalline carbohydrate and at least one hydrated crystalline compound, or
iii) at least one solid amorphous carbohydrate, or,
iv) at least one solid crystalline carbohydrate and at least one solid amorphous carbohydrate,
v) at least one solid crystalline carbohydrate and at least one solid amorphous carbohydrate and at least one hydrated crystalline compound or,
vi) a liquid solution or suspension of at least one carbohydrate.

The substantial crystalline state of the crystalline carbohydrate layer is key. Hence, the coating is either performed with crystalline carbohydrate or performed with non-crystalline carbohydrate which are converted into crystalline carbohydrate over the process.

Step Bi) of Coating with at Least One Solid Crystalline Carbohydrate

The coating step may be performed with at least one solid crystalline carbohydrate (step bi)). The solid crystalline carbohydrate is not a hydrated crystalline compound as described herein.

In an embodiment, the coating step bi) may be performed with at least two different solid crystalline carbohydrates, for example solid crystalline sucrose and solid crystalline fructose.

When the coating step is performed with at least one solid crystalline carbohydrate only (i.e. step bi)), the step bi) of coating comprises, after coating, a step of humidification, to trigger crystalline carbohydrate particles bridging. The humidification step is optionally followed by a drying step. This humidification followed by drying allows to have a carbohydrate layer which is cohesive and that remains around the food particle.

In a preferred embodiment, the humidification step in step bi) is performed by steaming. The drying step after the humidification step is optional when the humidification is performed by steaming. Indeed, the temperature of the steam during steaming tends to instantaneously dry the humidified carbohydrate so that a further step of drying may not be required.

In another embodiment, when the humidification is performed by any methods other than steaming, the drying step is not optional and is required.

In an embodiment, whatever the humidification method used, the drying step is not optional.

Step Bii) of Coating with at Least One Solid Crystalline Carbohydrate and at Least One Hydrated Crystalline Compound

Alternatively, the coating step may be performed with at least one solid crystalline carbohydrate and at least one hydrated crystalline compound (step bii)).

A hydrated crystalline compound is a food-grade compound in crystalline form that comprises at least one water molecule in its crystalline structure. Any hydrated crystalline compound that releases water upon heating is suitable for the invention and is known to the one skilled in the art.

For example, the hydrated crystalline compound may be selected from the list consisting of dextrose monohydrate, maltose monohydrate, trehalose dihydrate, raffinose pentahydrate, citric acid monohydrate and mixtures thereof.

The solid crystalline carbohydrate is not a hydrated crystalline compound as described herein.

In an embodiment, the coating step bii) may be performed with at least two different solid crystalline carbohydrates, for example solid crystalline sucrose and solid crystalline fructose.

When the coating step bii) is performed in presence of at least one solid crystalline carbohydrate and at least one hydrated crystalline compound, the step bii) comprises after coating, a step of heat treatment to trigger crystalline carbohydrate particles bridging. The heat treatment is preferably above the temperature at which the hydrated crystalline compound releases its water molecule(s). In a preferred embodiment, the temperature is below 80° C., preferably of 50-80° C.

The heat treatment releases the water molecule(s) from the hydrated crystallin compound. This triggers the deliquescence of crystalline carbohydrate and so triggers carbohydrate particles bridging. This ultimately allows to have a crystalline carbohydrate layer which is cohesive and that remains around the food particle.

In this embodiment, no step of humidification, optionally followed by drying step, is needed after the coating step to trigger the deliquescence of crystalline carbohydrate.

Step Biii) of Coating with at Least One Solid Amorphous Carbohydrate

Alternatively, the coating step may be performed with at least one solid amorphous carbohydrate (step biii)).

In an embodiment, the coating step biii) may be performed with at least two different solid amorphous carbohydrates, for example solid amorphous sucrose and solid amorphous lactose.

When the coating step is performed with at least one solid amorphous carbohydrate only (i.e. step biii)), the step biii) comprises, after coating, a step of heat treatment and/or humidification above (i.e. to exceed) the glass transition temperature Tg to trigger carbohydrate particles bridging and to convert amorphous carbohydrate into crystalline carbohydrate, wherein the humidification step is followed by a drying step.

The glass transition temperature Tg depends on the nature of the carbohydrate. The glass transition temperature of different carbohydrate and temperature/moisture conditions to reach or exceed such glass transition temperature Tg are well known to the one skilled in the art.

Step Biv) of Coating with at Least One Solid Crystalline Carbohydrate and at Least One Solid Amorphous Carbohydrate

Alternatively, the coating step may be performed with at least one solid crystalline carbohydrate and at least one solid amorphous carbohydrate (step biv)).

In an embodiment, the coating step biv) may be performed with at least two different solid amorphous carbohydrates, for example solid amorphous sucrose and solid amorphous lactose and/or at least two least two different solid crystalline carbohydrates, for example solid crystalline sucrose and solid crystalline fructose.

When the coating step is performed with at least one solid amorphous carbohydrate and at least one crystalline carbohydrate (i.e. step biv)), the step biv) optionally comprises, after coating, a step of heat treatment and/or humidification above (i.e. to exceed) the glass transition temperature Tg to trigger carbohydrate particles bridging and to convert amorphous carbohydrate into crystalline carbohydrate, wherein the humidification step is followed by a drying step.

The need for the heat treatment and/or humidification step depends on the ratio of crystalline carbohydrate and amorphous carbohydrate used for performing the coating step.

In particular, when the coating step is performed with at least 95% solid crystalline carbohydrate and the remainder being solid amorphous carbohydrate, this heat treatment and/or humidification may not be needed.

When the coating step is performed with less than 95% solid crystalline carbohydrate and the remainder being solid amorphous carbohydrate, this heat treatment and/or humidification step is needed in order to trigger the recrystallization of the amorphous fraction. This allows to ensure enough proportion of carbohydrate is in the crystalline state

In a preferred embodiment, the heat treatment and/or humidification step is not optional when the coating step is performed with crystalline carbohydrate and amorphous carbohydrate (i.e. step biv). Hence, in this preferred embodiment, the step biv) comprises, after coating, a step of heat treatment and/or humidification above (i.e. to exceed) the glass transition temperature Tg to convert amorphous carbohydrate into crystalline carbohydrate, wherein the humidification step is followed by a drying step.

The glass transition temperature Tg depends on the nature of the carbohydrate. The glass transition temperature of different carbohydrate and temperature/moisture conditions to reach or exceed such glass transition temperature Tg are well known to the one skilled in the art.

Step Bv) of Coating with at Least One Solid Crystalline Carbohydrate and at Least One Solid Amorphous Carbohydrate and at Least One Hydrated Crystalline Compound

Alternatively, the coating step may be performed with at least one solid crystalline carbohydrate and at least one solid amorphous carbohydrate and at least one hydrated crystalline compound (step bv)).

The hydrated crystalline compound may be an hydrated crystalline compound as disclosed herein for step bii).

The solid crystalline carbohydrate is not a hydrated crystalline compound as described herein.

In an embodiment, the coating step bv) may be performed with at least two different solid amorphous carbohydrates, for example solid amorphous sucrose and solid amorphous lactose and/or at least two least two different solid crystalline carbohydrates, for example solid crystalline sucrose and solid crystalline fructose.

When the coating step bv) is performed in presence of at least one solid crystalline carbohydrate, at least one solid amorphous carbohydrate and at least one hydrated crystalline compound, the step bv) optionally comprises, after coating, a step of heat treatment above the glass transition temperature Tg to trigger carbohydrate particles bridging and to convert amorphous carbohydrate into crystalline carbohydrate. The heat treatment may be also above the temperature at which the hydrated crystalline compound releases its water molecule(s).

The need for the heat treatment step depends on the ratio of crystalline carbohydrate and amorphous carbohydrate used for performing the coating step.

In particular, when the coating step is performed with at least 95% solid crystalline carbohydrate and the remainder being solid amorphous carbohydrate and hydrated crystalline compound, this heat treatment may not be needed.

When the coating step is performed with less than 95% solid crystalline carbohydrate and the remainder being solid amorphous carbohydrate and hydrated crystalline compound, this heat treatment is needed in order to trigger the recrystallization of the amorphous fraction. This allows to ensure enough proportion of carbohydrate is in the crystalline state

In a preferred embodiment, the heat treatment and/or humidification step is not optional when the coating step is performed with crystalline carbohydrate, amorphous carbohydrate and hydrated crystalline compound (i.e. step bv).

Hence, in this preferred embodiment, the step bv) comprises, after coating, a step of heat treatment above (i.e. to exceed) the glass transition temperature Tg to trigger carbohydrate particles bridging and to convert amorphous carbohydrate into crystalline carbohydrate.

The glass transition temperature Tg depends on the nature of the carbohydrate. The glass transition temperature of different carbohydrate and temperature/moisture conditions to reach or exceed such glass transition temperature Tg are well known to the one skilled in the art.

The heat treatment should be also above the temperature at which the hydrated crystalline compound releases its water molecule(s) to trigger carbohydrate particles bridging. The temperature at which the hydrated crystalline compound releases its water molecule(s) is typically above 40° C. to 80° C.

Hence, the temperature of the heat treatment should be selected such that it is above Tg and above the temperature at which the hydrated crystalline compound releases its water molecule(s).

Hence, as above the water release temperature, the heat treatment allows to release the water molecule(s) from the hydrated crystallin compound. This triggers the deliquescence of crystalline carbohydrate, and so triggers carbohydrate particles bridging. This ultimately allows to have a crystalline carbohydrate layer which is cohesive and that remains around the food particle. In this embodiment, no step of humidification, optionally followed by drying step, is needed after the coating step to trigger the deliquescence of crystalline carbohydrate.

In addition, as above Tg, the heat treatment allows to convert amorphous carbohydrate into crystalline carbohydrate to ensure a sufficient level of crystallinity in the crystalline carbohydrate layer.

Step Bvi) of Coating with a Liquid Solution or Suspension of at Least One Carbohydrate

Alternatively, the coating step may be performed with a liquid solution or suspension of at least one carbohydrate (step bvi)).

The liquid solution of carbohydrate comprises a solvent and carbohydrate. In particular, the liquid solution consists of a carbohydrate fully or partly dissolved in a solvent. Where part of the carbohydrate is not dissolved in the solvent, the liquid solution of carbohydrate is a liquid suspension of carbohydrate. The solvent may be an aqueous liquid, preferably water.

The liquid solution of carbohydrate may comprise above 30 wt. % carbohydrate. In an embodiment, the liquid solution of carbohydrate is saturated or supersaturated in carbohydrate. In a more preferred embodiment, the liquid solution of carbohydrate is saturated in carbohydrate. The person skilled in the art knows the concentration of a carbohydrate which is required to saturate a liquid solution. The liquid solution of carbohydrate which is saturated in carbohydrate may comprise dissolved and undissolved carbohydrate. The presence of undissolved carbohydrate particles in the saturated solution is advantageous. It will enable faster and easier recrystallisation of dissolved carbohydrate during the cooling and/or drying step(s) which is/are after the coating step.

In an embodiment, the coating step bvi) may be performed with liquid solutions or suspensions of at least two different carbohydrates, for example liquid solution of lactose and sucrose.

When the coating step is performed with a liquid solution or suspension of at least one carbohydrate (i.e. step bvi)), the step bvi) comprises, after coating, a drying step, optionally preceded by a cooling step to convert carbohydrate dissolved in the liquid solution or suspension of at least one carbohydrate into crystalline carbohydrate. In particular, the drying step, and the optional cooling step which precedes the drying step is/are performed to exceed the saturated state of the carbohydrate. The drying step may be performed by heat treatment.

In an embodiment, the drying step and the step of coating with a liquid solution or suspension of at least one carbohydrate may be simultaneous.

In an embodiment, the step bvi) comprises a step of dry mixing the food particles with a carbohydrate, preferably a micronized carbohydrate having a D90 particle size at least 5 times, preferably at least 8 times, more preferably at least 10 times lower than the D[3,2] particle size of the one or plurality of food particles. The D90 particle size may be measured by using a particle size analyser, in particular CamSizer XT (Retsch Technology GmbH, Germany). The D90 value is the diameter of a particle size distribution below which 90% of the particles in a sample exist. D90 is expressed in number basis (not volume basis).

The dry mixing step is prior the step of coating with a liquid solution or suspension of at least one carbohydrate. Alternatively, the dry mixing step and the step of coating with a liquid solution or suspension of at least one carbohydrate are simultaneous. This promotes Van der Waals interaction between the carbohydrate and the food particles and so facilitates the step of coating. This also promotes recrystallization of the dissolved carbohydrate during drying step.

In a preferred embodiment, the step bi), bii), biii), biv) and bv) of coating are performed with a carbohydrate having a D90 particle size at least 5 times, preferably at least 8 times, more preferably at least 10 times lower than the D[3,2] particle size of the one or plurality of food particles. This promotes Van der Waals interaction between the carbohydrate and the food particles and facilitates the step of coating. More preferably, the carbohydrate is micronized.

The crystalline carbohydrate layer comprises at least 95% crystalline carbohydrate. Preferably, crystalline carbohydrate layer comprises at least 98%, more preferably 99%, most preferably 100% crystalline carbohydrate.

The crystalline carbohydrate layer may also have a closed porosity lower than 10%, preferably lower than 5%, more preferably lower than 2%, even more preferably of 0%.

The closed porosity refers in general terms to the total amount of void or space that is trapped within a solid. In the present invention, the term closed porosity is further defined as the ratio of the volume of closed voids or pores in a solid to the solid volume.

The closed porosity is calculated from the matrix density and the apparent density, according to the following equation:

$$Closed porosity = 100 - ( 1 - \frac{ρ ( apparent )}{ρ ( matrix )} ) .$$

The apparent density of the crystalline carbohydrate layer is measured by Accupyc 1330 Pycnometer (Micrometrics Instrument Corporation, US). The instrument determines density and volume by measuring the pressure change of helium in a calibrated volume with an accuracy to within 0.03% of reading plus 0.03% of nominal full-scale cell chamber volume.

The matrix density of the crystalline carbohydrate layer is determined at 20° C. with a density meter, in particular DMA 4500 M (Anton Paar, Switzerland AG). The sample is introduced into a U-shaped borosilicate glass tube that is excited to vibrate at its characteristic frequency which depends on the density of the sample. In particular, 1.5 g of the sample is put in about 100 g of water in bottle shot, the bottle is closed and put under agitation for 1 h. The sample is then put under ultrasonic bath for 5 min just before each measurement with the density meter.

The closed porosity of the crystalline carbohydrate layer may be measured on the crystalline carbohydrate layer which has been separated from the food particle.

The closed porosity of the crystalline carbohydrate layer may also be measured on the coated food particles. In particular, the closed porosity may be measured on the food particle before coating with the crystalline carbohydrate layer and on the coated food particle after coating with the crystalline carbohydrate layer. The difference of the closed porosity before and after coating provides the closed porosity of the crystalline carbohydrate layer.

Alternatively, the closed porosity of the crystalline carbohydrate layer may be measured via X-Ray tomography with high resolution.

The crystalline carbohydrate layer and its porosity enables to retain quality, properties and improve stability of the food particle(s) over the shelf life by limiting, or even preventing contact and flux between the food particle(s) and the external environment. The crystalline state of the crystalline carbohydrate layer and its low porosity are key to achieve effective protection of the food particle(s) and of the overall food composition. In particular, the crystalline carbohydrate layer protects the food particle(s) from factors of the external environment, e.g. moisture, elevated temperature or mechanical constraints, that may negatively impact the properties including sensory, nutritional, stability, functional and/or microbiological properties, of the food particle(s). It may also prevent volatile compounds, such as aroma, to be released from the food particle(s) in the environment. Hence, the resulting food composition retains acceptable properties including sensory, nutritional, stability, functional and/or microbiological properties, over shelf life, even in presence of important moisture.

When the food composition is a food powder, the powder comprising crystalline carbohydrate layer according to the invention exhibits limited moisture uptake over shelf life compared to a powder without such a crystalline carbohydrate layer. This limited moisture uptake limits undesirable phenomenon such as caking and spoilage of the powder over shelf life. The use of crystalline carbohydrate is also advantageous as it does not adversely affect the reconstitution properties of the powder in aqueous liquid, e.g. water, milk, juice or plant-based milk alternative.

In other words, thanks to its composition, the crystalline carbohydrate layer is a protective barrier. In particular, the crystalline carbohydrate layer is a moisture barrier and/or mechanical barrier and/or gas barrier (e.g. oxygen barrier), and/or light barrier (e.g. UV light barrier) and/or aroma barrier. Preferably, the crystalline carbohydrate layer is a moisture barrier and/or mechanical barrier and/or aroma barrier. More preferably, the crystalline carbohydrate layer is a moisture barrier and/or mechanical barrier.

The crystalline carbohydrate layer also provides good stability towards elevated temperature. In particular, no product deterioration or properties degradation, incl. caking is observed when the coated food particles are exposed to temperature increase or fluctuations. Hence, in some embodiment, the one or plurality of coated food particles is/are heat-stable, in particular at a temperature below the melting point of the crystalline carbohydrate layer. By “heat-stable”, it means that the food composition does not exhibit caking and/or the coated food particles are not deteriorated when exposed to a temperature below the melting point of the crystalline carbohydrate layer.

The crystalline carbohydrate layer provides outstanding barrier properties. Hence, it can be used for the encapsulation of sensitive ingredients such as flavouring agents, vitamins, probiotics, food-grade active ingredients.

In an embodiment, the crystalline carbohydrate layer consists of at least one carbohydrate. In other words, the crystalline carbohydrate layer does not comprise any compounds different from carbohydrate, such as fats, proteins, vitamins, minerals and the like. In particular, the carbohydrate of the crystalline carbohydrate layer may be selected from the list consisting of lactose, sucrose, fructose, maltose, glucose, galactose, polyol, allulose, dextrose and mixtures thereof. Preferably, the carbohydrate of the crystalline carbohydrate layer is sucrose and/or lactose, more preferably sucrose.

In an embodiment, the crystalline carbohydrate layer is free from maltodextrin and/or starch and/or carbohydrate-based hydrocolloid (such as gum Arabic) and/or dietary fibers (e.g. fructooligosaccharides) and/or honey and/or maple syrup and/or agave syrup. Examples of carbohydrate-based hydrocolloid include gum arabic, gelatin, xanthan gum, alginate, pectin, agar, guar gum, gellan gum, carrageenan, locust bean gum and mixture thereof. Examples of dietary fibers include fructooligosaccharides, maltooligosaccharides, galactooligosaccharides, beta-glucans, cellulose, inulin, arabinoxylan, polydextrose and mixture thereof. These compounds are undesirable as they are not crystalline or not fully crystalline. In other words, they are amorphous or comprise amorphous fractions. Hence, they can negatively impact the barrier properties of the coating layer.

In an embodiment, the crystalline carbohydrate layer is free from fat. Fat is not advantageous in the coating layer (i.e. crystalline carbohydrate layer) for several reasons. First, a coating layer with fat has very limited reconstitution properties mainly in cold and/or hot hydrophilic liquid. Hence, the use of such a coating layer would negatively impact the overall reconstitution properties of the food composition, in particular in cold and/or hot hydrophilic liquid. In addition, upon reconstitution, fat will form undesirable fat “lenses” (or droplets) visible to the naked eyes at the surface of the reconstituted food composition, e.g. at the surface of the reconstituted beverage. Such fat “lenses” negatively impact the appearance of the food composition. Moreover, the coating corresponds to the outer layer and so is exposed to the atmosphere. Hence, fat, depending on its nature, may undergo oxidation. This oxidation may negatively impact the organoleptic properties of the food composition by providing undesirable rancid notes. Finally, fat may negatively impact the nutritional properties of the food composition and so should be limited, and even preferably avoided.

In a more preferred embodiment, the carbohydrate of the crystalline carbohydrate layer consists only of carbohydrate in the crystalline form. In other words, the crystalline carbohydrate layer is free from carbohydrate in the amorphous form. The presence of crystalline carbohydrates as unique source of carbohydrates in the crystalline carbohydrate layer enhances its protection properties. The carbohydrate in the crystalline form of the crystalline carbohydrate layer may be selected from crystalline lactose, crystalline sucrose, crystalline fructose, crystalline maltose, crystalline glucose, crystalline galactose, crystalline polyol, crystalline allulose, crystalline dextrose and mixtures thereof. Preferably, the carbohydrate in the crystalline form of the crystalline carbohydrate layer may be crystalline sucrose and/or crystalline lactose, more preferably crystalline sucrose.

The present invention does not require to increase the carbohydrate content of the food composition. In particular, the carbohydrate generally used in a food composition may be deducted from the recipe of the food particles and the carbohydrate which is deducted from the recipe may be used to prepare the coating. Hence, the stability of the food composition may be improved through the application of the crystalline carbohydrate layer as coating while maintaining the same amount of carbohydrate in the food composition.

In an embodiment, the crystalline carbohydrate layer has thickness of at least 100 microns, preferably at least 130 microns, more preferably at least 138.5 microns, even more preferably at least 200 microns, most preferably at least 300 microns. This minimum thickness ensures the provision of a robust and solid crystalline carbohydrate layer which does not form easily cracks which span along the entire thickness of the layer. Such cracks would drastically decrease, or even remove, the protective properties of the crystalline carbohydrate layer. In certain embodiment, it may be desired to limit the thickness of the crystalline carbohydrate layer to limit the carbohydrate intake upon consumption. Preferably, it may have thickness of 100 microns to 1 cm, preferably 130 microns to 1 cm, more preferably 138.5 microns to 1 cm, even more preferably 200 microns to 1 cm, most preferably 300 microns to 1 cm. In an embodiment, the thickness of the crystalline carbohydrate layer, is essentially the same, preferably the same across the whole surface area of the crystalline carbohydrate layer.

In an embodiment, the step b) of coating, in particular the step bi), bii), biii), biv), bv) or bvi) may be repeated several times. Preferably, the step b) of coating, in particular the step bi), bii), biii), biv), bv) or bvi) may be repeated several times until the thickness of the crystalline carbohydrate layer reaches at least 100 microns, preferably at least 130 microns, more preferably at least 138.5 microns, even more preferably at least 200 microns, even more preferably at least 300 microns. In a more preferred embodiment, the step b) of coating, in particular the step bi), bii), biii), biv), bv) or bvi) may be repeated several times until the thickness of the crystalline carbohydrate layer reaches 100 microns to 1 cm, preferably 130 microns to 1 cm, more preferably 138.5 microns to 1 cm, even more preferably 200 microns to 1 cm, most preferably 300 microns to 1 cm.

The step b) of coating may be performed by any coating technology known to the person skilled in the art. This can be performed, for example, by dry mixing, fluid bed coating, pan coating, conveyor coating, drum coating, immersion coating, multilayer tabletting, or dip coating. The step b) of coating is performed such that the crystalline carbohydrate layer covers the entire surface of the food particle. This provides a full protection of the food particle from the external environment. In a preferred embodiment, the step b) of coating is performed by fluid bed coating, in particular by spheronization.

In a specific embodiment, the method further comprises a step of applying a hydrophobic layer on the one or plurality of food particles between step a) and step b). As a result, the coated food particles comprise the hydrophobic layer between the surface of the food particles and the crystalline carbohydrate layer. The hydrophobic layer may comprise fat or surfactant. The fat may be fat which is food grade such as vegetable oil or solid fat. The surfactant may be any food grade surfactant known to skilled artisans that is food grade. The surfactant is preferably lecithin. This hydrophobic layer may contribute to facilitate the coating process of food particles, in particular the hydrophobic ones and/or may contribute to avoid water/steam transfer to the food particles during the coating process.

In a further embodiment, at least 50%, preferably at least 75%, most preferably 100% of the one or plurality of coated food particles of the food composition do not have any edges with an angle less than 80°. This avoids acute edges that may generate weakness zones propitious to cracks. These cracks would weaken the barrier properties of the crystalline carbohydrate layer and so are not desirable. For example, the coated food particles may be a polyhedron, preferably polyhedron with rounded edges, more preferably substantially a sphere, most preferably a sphere.

In an embodiment, the crystalline carbohydrate layer has a water vapor transmission rate (WVTR) of at most 1 g/m²/day, preferably between 0.1 g/m²/day and 1 g/m²/day at a relative humidity of 85% and at a temperature of 23° C. The WVTR may be measured with the same method as described in example 18. These WVTR values correspond to a crystalline carbohydrate layer with good barrier properties, in particular good barrier properties to moisture. In some embodiment, the crystalline carbohydrate layer has a water vapor transmission (WVTR) of at most 1 g/m²/day, preferably between 0.1 g/m²/day and 1 g/m²/day over at least 3 months, preferably at least 6 months, more preferably at least 9 months at a relative humidity of 85% and at a temperature of 23° C.

In some embodiment, the crystalline carbohydrate layer is the outer layer of the coated food particles. In particular, the crystalline carbohydrate layer is in contact with the atmosphere. In an embodiment, the food particles, i.e. the food particles that are surrounded by the crystalline carbohydrate layer, are not in contact with the atmosphere.

In a second aspect, the invention relates to a coated food particle.

The coated food particle comprises a food particle. The food particle may be food particle as provided in the first aspect of the invention.

The food particle is coated with crystalline carbohydrate layer. The crystalline carbohydrate layer comprises at least 95% crystalline carbohydrate, in particular at least 95% crystalline carbohydrate particles.

In an embodiment, the crystalline carbohydrate layer has a closed porosity lower than 10%.

The advantages and further features for the crystalline carbohydrate layer are provided in the first aspect of the invention.

The coated food particle is heat-stable, in particular at a temperature below the melting point of the crystalline carbohydrate layer. By “heat-stable”, it means that the coated food particle is not inclined to caking in presence of other food particles and/or the coated food particle is not deteriorated, when exposed to a temperature below the melting point of the crystalline carbohydrate layer.

The crystalline carbohydrate layer covers essentially, preferably covers the entire surface of the food particle.

In a third aspect, the invention relates to a food composition comprising one or a plurality of coated food particles according to the second aspect of the invention. In particular, the food composition may be obtainable or obtained by the method according to the first aspect of the invention.

Those skilled in the art will understand that they can freely combine all features of the present invention disclosed herein. In particular, features described for the products of the present invention may be combined with the method of the present invention and vice versa. Further, features described for different embodiments of the present invention may be combined.

Furthermore, where known equivalents exist to specific features, such equivalents are incorporated as if specifically referred in this specification. Further advantages and features of the present invention are apparent from the figures and non-limiting examples.

### EXAMPLES

### Example 1: Production of Coated Coffee Granules

Coated coffee granules were produced according to the invention.

In particular, coffee powder was pre-granulated by roller compaction (Alexanderwerk) to form granules having a D[3,2] particle size between 0.8 and 1.6 mm.

The coffee granules were fluidised in a fluid bed. The coating of the coffee granules was performed by adding micronized crystalline sucrose (D90 particle size below 100 μm) in dry with the fluidised coffee granules while simultaneously spraying concentrated sucrose solution (65% sucrose) at a temperature of 60° C. which dried and crystallised the dissolved sucrose directly. The coating was performed until forming a homogenous layer having a thickness of at least 200 microns. This resulted in coffee granules coated with crystalline sucrose coating, said coating comprising 100% crystalline sucrose and having a closed porosity of less than 2%.

The fluidisation and coating were performed using “GXR” GRANUREX© from Freund Vector.

17-24 g coated coffee granules were dissolved in 180-250 mL water and exhibit great reconstitution properties in less than 2 minutes.

### Example 2: Production of Coated 3-In-One Coffee Mix Granules

Coated 3-in-one coffee mix granules were produced according to the invention.

Coffee powder was taken to produce 3-in-1 coffee mix granules and compacted to form small granules having a D[3,2] particle size between 0.8 and 1.6 mm

The small coffee granules were further coated via spheronization at 60° C. with coffee to increase the particle size and form large coffee granules having a D[3,2] particle size between 1.0 and 3.5 mm.

The coffee granules were fluidised in a fluid bed. Micronized creamer powder (D90 particle size below 100 μm) is added in dry with the fluidised coffee granules while simultaneously spraying concentrated creamer solution (65% creamer) at 60° C. which dried the layer directly. The coating was performed until forming a homogenous layer having a thickness of at least 200 microns. Coffee granules coated with creamer, hereinafter coffee/creamer granules, were obtained.

The obtained coffee/creamer granules were fluidised and coated with sucrose. Micronized crystalline sucrose (D90 particle size below 100 μm) was added in dry into the fluidised coffee/creamer granules while simultaneously spraying concentrated sucrose solution (65% sucrose) at 60° C. which dried and crystallised the dissolved sucrose directly. The coating was performed until forming a homogenous layer having a thickness of at least 200 microns. This resulted in 3-in-one coffee mix granules coated with crystalline sucrose coating, said coating comprising 100% crystalline sucrose and having a closed porosity of less than 2%.

The different steps of spheronization, fluidisation and coating were performed using “GXR” GRANUREX® (Freund Vector).

17-24 g coated 3-in-one coffee mix granules were dissolved in 180-250 mL water and exhibit great reconstitution properties in less than 2 minutes.

### Example 3: Production of Coated Cocoa Granules

Coated cocoa granules were produced with the same method as in example 2.

In this example, cocoa powder instead of coffee powder underwent pre-granulation and spheronization to form granules. In addition, micronized milk powder (D90 particle size below 100 μm) and concentrated milk powder solution (65% milk) were used instead of the micronized creamer powder and concentrated creamer powder solution to form milk-coated cocoa granules.

The milk-coated cocoa granules were finally coated with sucrose with same operations, including same sucrose ingredients as in example 2 to obtain milk/cocoa granules coated with crystalline sucrose coating, said coating comprising 100% crystalline sucrose and having a closed porosity of less than 2%

17-24 g sucrose-coated milk/cocoa granules were dissolved in 180-250 mL water and exhibit great reconstitution properties in less than 2 minutes.

### Examples 4: Production of Coated Milk Powder Granules

Coated milk powder granules were produced with a similar method as in example 1. In this example, milk powder instead of coffee powder was pre-granulated to form granules.

The milk granules were fluidised in a fluid bed. The coating of the milk granules was performed by adding micronized crystalline lactose (D90 particle size below 100 μm) in dry with the fluidised milk granules while simultaneously spraying concentrated lactose solution (40% lactose) at a temperature of 60° C. which dried and crystallised the dissolved lactose directly. The coating was performed until forming a homogenous layer having a thickness of at least 200 microns.

This resulted in milk granules coated with crystalline lactose coating, said coating comprising 100% crystalline lactose and having a closed porosity of less than 2%.

The fluidisation and coating were performed using “GXR” GRANUREX® from Freund Vector.

17-24 g coated milk powder granules were dissolved in 180-250 mL water and exhibit great reconstitution properties in less than 2 minutes.

### Example 5: Production of Coated Fruit Powder Granules

Coated fruit powder granules were produced with the same method as in example 2. In the present example, fruit powder granules (e.g. banana and strawberry) instead of coffee underwent spheronization. In addition, micronized milk powder (D90 particle size below 100 μm) and concentrated milk powder solution (65% milk) were used instead of the micronized creamer powder and concentrated creamer powder solution to form fruit granules coated with milk, hereinafter fruit/milk granules.

The fruit/milk granules were then coated with sucrose with the same operations, including same sucrose ingredients as in example 2.

This resulted in fruit/milk granules coated with crystalline sucrose coating, said coating comprising 100% crystalline sucrose and having a closed porosity of less than 2%.

17-24 g coated coffee granules were dissolved in 180-250 mL water and exhibit great reconstitution properties in less than 2 minutes.

### Example 6: Assessment of Moisture Uptake of Coffee and 3-In-1 Coffee Mixes

### Sample Preparation

Different samples of coffee and 3-in-1 coffee mix were prepared.

Sample 1: Compacted coffee was prepared by transforming coffee powder into coffee granules having D[3,2] particle size of about 1.6 mm with a roller compacter (Alexanderwerk).

Sample 2: Spheronized coffee without coating was prepared by transforming coffee granules of sample 1 into spherical coffee granules having D[3,2] particle size of 2.2-3.4 mm by fluid bed coating at 60° C., in particular spheronization using “GXR” GRANUREX® (Freund Vector).

Sample 3: Spheronized coffee mix with non-crystalline coating (i.e. creamer coating) was prepared by transforming spherical coffee granules of sample 2 into spheronized creamer/coffee granules (or spheronized coffee mix granules) having D[3,2] particle size of 2.5-3.7 mm.

The spherical coffee granules of sample 2 were fluidized in a fluid bed. Micronized creamer powder (D90 particle size below 100 μm) is added in dry with the fluidised spherical coffee granules while simultaneously spraying concentrated creamer solution (65% creamer) at 60° C. which dried the layer directly. The coating was performed until forming a creamer coating having a thickness of 300 microns at the surface of spherical coffee granules of sample 2. The fluidisation and coating were performed using GXR” GRANUREX© (Freund Vector).

Sample 4: Spheronized 3-in-1 coffee mix with crystalline coating (i.e. crystalline sucrose coating) was prepared by transforming the spheronized coffee mix granules of sample 3 into crystalline sucrose-coated spheronized coffee mix granules (or spheronized 3-in 1 coffee mix granules) having D[3,2] particle size of 2.8-3.3 mm.

The spheronized coffee mix granules of sample 3 having D[3,2] particle size of 2.5-3.0 were fluidised in a fluid bed. Micronized sucrose (D90 particle size below 100 μm) is added in dry with the fluidised spheronized coffee mix granules while simultaneously spraying concentrated sucrose solution (65% sucrose) at 60° C. which dried the layer and crystallised the dissolved sucrose directly. The coating was performed until forming a sucrose coating having a thickness of 300 microns at the surface of spheronized coffee mix granules of sample 3. The fluidisation and coating were performed using GXR” GRANUREX® (Freund Vector).

This resulted in a 3-in-1 coffee mix granules coated with a crystalline sucrose coating, said coating comprising 100% crystalline sucrose and having a closed porosity of less than 2%.

Sample 5: Spheronized 3-in-1 coffee mix with crystalline coating (i.e. crystalline sucrose coating) was prepared by transforming the spheronized coffee mix granules of sample 3 into crystalline sugar-coated spheronized coffee mix granules (or spheronized 3-in-1 coffee mix granules) having D[3,2] particle size of 3.4-4.0 mm.

The spheronized coffee mix granules of sample 3 having D[3,2] particle size of 3.1-3.7 mm were fluidised in a fluid bed. Micronized sucrose (D90 particle size below 100 μm) is added in dry into the fluidised spheronized coffee mix granules while simultaneously spraying concentrated sucrose solution (65% sucrose) at 60° C. which dried the layer and crystallised the dissolved sucrose directly. The coating was performed until forming a sucrose coating having a thickness of 300 microns at the surface of spheronized coffee mix granules of sample 3. The fluidisation and coating were performed using GXR” GRANUREX® (Freund Vector).

This resulted in a 3-in-1 coffee mix granules coated with a crystalline sucrose coating, said coating comprising 100% crystalline sucrose and having a closed porosity of less than 2%.

### Moisture Uptake Assessment

The moisture uptake was assessed for the different samples. In particular, moisture sorption experiments were conducted in the water sorption equipment SPS (proUmid, Ulm). The same volume of sample was placed in the aluminium pans and tared. The different samples were then equilibrated at 25° C., 13% relative humidity until reaching an equilibrium. Subsequently the relative humidity was increased from 13 to 40%. The resulting weight gain relates to the quantity of moisture absorbed by the sample.

### Results

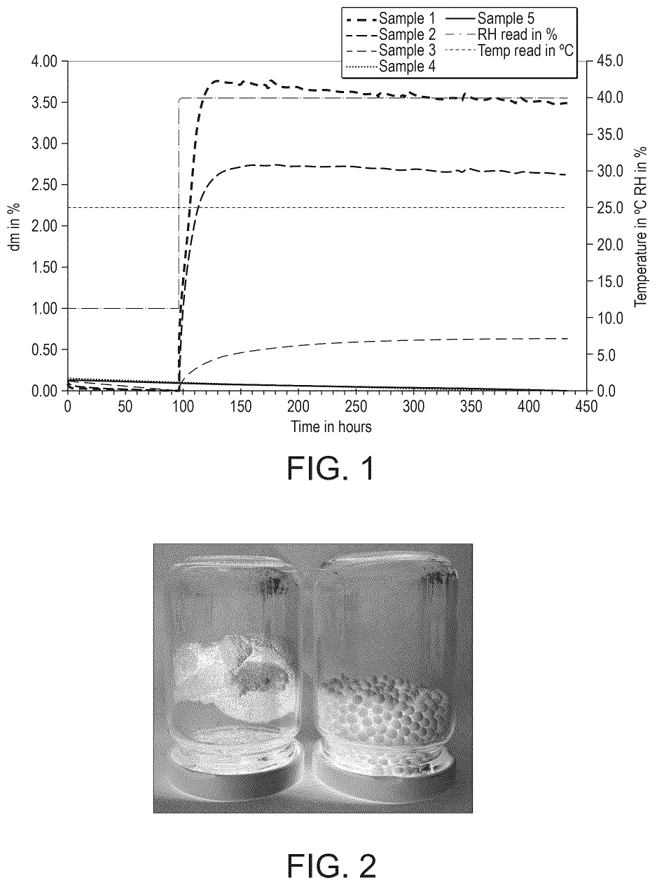

The results of moisture sorption experiments are shown in FIG. 1.

It can be observed in FIG. 1 that the increase in particle size allows to decrease the moisture pick up during shelf storage.

In addition, it can also be observed that the application of a crystalline or a non-crystalline coating on coffee decreases moisture pick-up during shelf-life by the coffee compared to compacted or spheronized coffee with without any coating.

However, spheronized 3-in-1 coffee mix with a crystalline sucrose coating did not undergo any moisture pick up while spheronized coffee mix with a non-crystalline coating still underwent significant moisture pick up. Hence, it appears that a crystalline carbohydrate coating is key to avoid moisture absorption throughout the entire shelf life.

17-24 g of the powder of sample 4 and 5 were respectively reconstituted in 180-250 mL water and exhibit great reconstitution properties in less than 2 minutes. In particular, this demonstrates that the crystalline carbohydrate coating provides good barrier properties to the powder while not impacting negatively its reconstitution properties. In particular, the powder keeps good reconstitution properties when added in aqueous liquid.

### Example 7: Assessment of Temperature Stability

To evaluate the physical stability in terms of temperature robustness, heat shock tests were performed.

The physical stability was assessed on two different samples:
spheronized 3-in-1 coffee mix with crystalline coating of sample 4 of example 6 (hereinafter, spheronized coffee mix),
reference 3-in-1 coffee mix powder prepared by dry mixing creamer, coffee and sucrose in the same proportion as for the spheronized 3-in-1 coffee mix of sample 4 of example 6 (hereinafter, reference coffee mix).

For this, 17 g of a reference coffee mix or the spheronized coffee mix were filled into glass jars, closed (no change of humidity) and placed in the oven. The samples were left at 60° C. for 7 days.

Samples in glass jars were inspected visually and agitated by hand after 1, 2, 3, 5 and 7 days to evaluate powder flowability and caking.

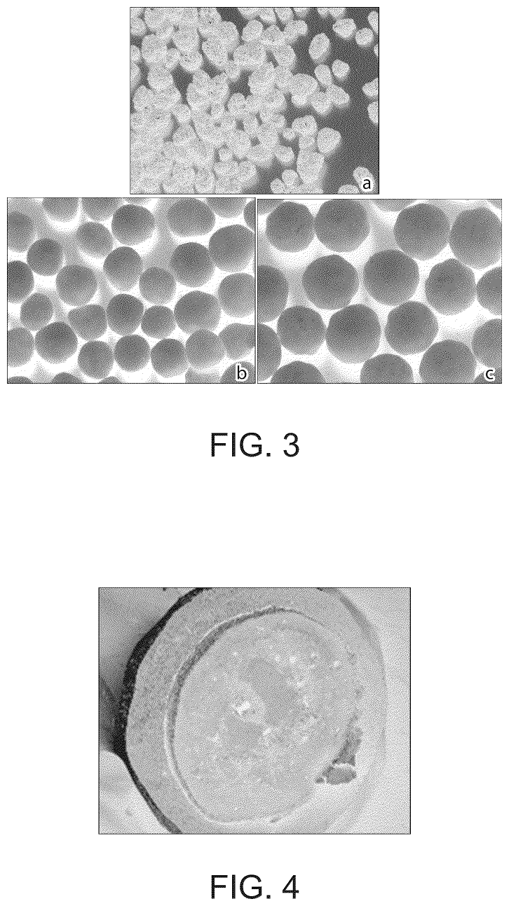

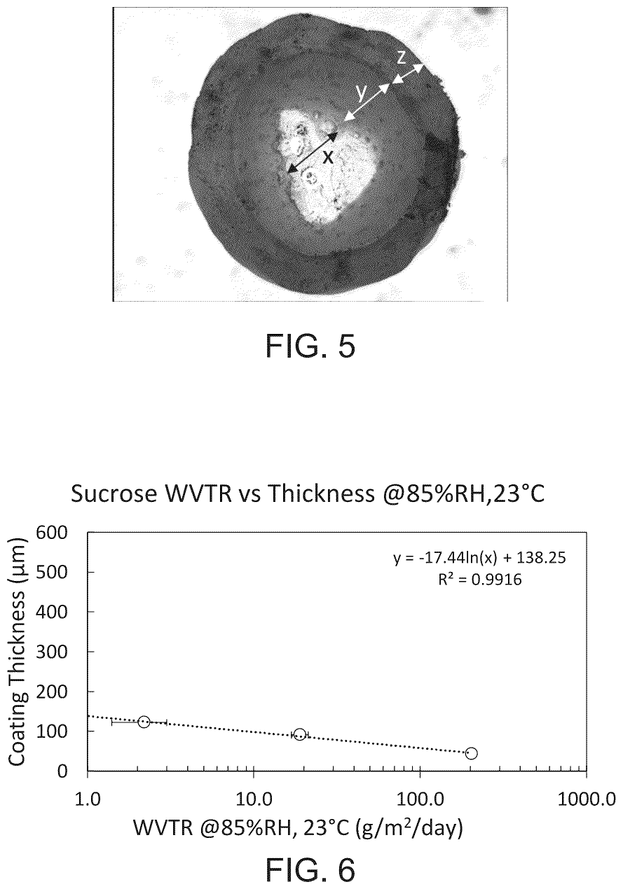

Powder caking and formation of lumps that cannot be broken easily by shaking the glass vials, was observed in the loose powder of the reference coffee mix after 7 days of storage (cf. FIG. 3, left).

For the spheronized coffee mix, no caking, no impact on flowability and even great flowability were observed when exposed to high temperatures, even for longer durations such as 3 weeks. In addition, the spheronized coffee mix showed good mechanical resistance to shaking.

It is observed that the crystalline coating allows to improve the stability of the coffee mix over the shelf-life, even when exposed to high temperatures. In particular, no caking occurred.

### Example 8: Coating of Coffee Granules with a Single Solid Crystalline Carbohydrate (Humid Air)

Coated coffee granules were produced according to the invention.

In particular, coffee powder was pre-granulated by roller compaction (Alexanderwerk) to form granules having a D[3,2] particle size between 0.8 and 1.6 mm.

The coffee granules were then dry mixed with micronized crystalline sucrose (D90 particle size below 100 μm) to form a thin coating.

The thin coating of granules was then humidified with humid air at 90% relative humidity (RH), above the critical humidity of deliquescence (transition from crystalline solid to solution due to humidity in environment) of the sucrose (85% RH) and then dried. This triggered carbohydrate particles bridging and allowed to form a dense coating of crystalline sucrose.

Stepwise layering coating (pan coating) was performed by repeating dry mixing, humidification and drying operations until forming a homogenous coating having a thickness of at least 200 microns.

This resulted in coffee granules coated with crystalline sucrose coating, said coating comprising 100% crystalline sucrose and having a closed porosity of less than 2%.

17-24 g coated coffee granules were dissolved in 180-250 mL water and exhibit great reconstitution properties in less than 2 minutes.

### Example 9: Coating of Coffee Granules with a Single Solid Crystalline Carbohydrate (Steam)

Coated coffee granules were produced according to the invention.

In particular, coffee powder was pre-granulated by roller compaction (Alexanderwerk) to form granules having a D[3,2] particle size between 0.8 and 1.6 mm.

The coffee granules were then dry mixed with micronized crystalline sucrose (D90 particle size below 100 μm) to form a thin coating.

The thin coating of granules was steamed, enabling to simultaneously humidify and dry the crystalline layer. This triggered carbohydrate particles bridging and allowed to form a dense coating of crystalline sucrose.

Stepwise layering coating (pan coating) was performed by repeating dry mixing and steaming operations until forming a homogenous coating having a thickness of at least 200 microns.

This resulted in coffee granules coated with crystalline sucrose coating, said coating comprising 100% crystalline sucrose and having a closed porosity of less than 2%.

17-24 g coated coffee granules were dissolved in 180-250 mL water and exhibit great reconstitution properties in less than 2 minutes.

### Example 10: Coating of Coffee Granules with a Mix of Solid Crystalline Carbohydrates (Humid Air)

Coated coffee granules were produced according to the invention.

In particular, coffee powder was pre-granulated by roller compaction (Alexanderwerk) to form granules having a D[3,2] particle size between 0.8 and 1.6 mm.

The coffee granules were then dry mixed with a mix of micronized crystalline sucrose and fructose (95/5 ratio, D90 particle size below 100 microns) to form a thin coating.

The thin coating of granules was humidified with humid air at 65% RH, above the critical humidity of deliquescence of the crystalline sucrose/fructose mix (53% RH) and then dried. This triggered carbohydrate particles bridging and allowed to form a dense coating of crystalline sucrose and fructose.

Stepwise layering coating (pan coating) was performed by repeating dry mixing, humidification and drying operations until forming a homogenous coating having a thickness of at least 200 microns.

This resulted in coffee granules coated with a 100% crystalline sucrose/fructose (95/5 ratio) coating, having a closed porosity of less than 2%.

17-24 g coated coffee granules were dissolved in 180-250 mL water and exhibit great reconstitution properties in less than 2 minutes.

### Example 11: Coating of Coffee Granules with a Mix of Solid Crystalline Carbohydrates (Steam)

Coated coffee granules were produced according to the invention.

In particular, coffee powder was pre-granulated by roller compaction (Alexanderwerk) to form granules having a D[3,2] particle size between 0.8 and 1.6 mm.

The coffee granules were then dry mixed with a mix of micronized crystalline sucrose and fructose (95/5 ratio, D90 particle size below 100 microns) to form a thin coating.

The thin coating of granules was steamed, enabling to simultaneously humidify and dry the crystalline layer. This triggered carbohydrate particles bridging and allowed to form a dense coating of crystalline sucrose and fructose.

Stepwise layering coating (pan coating) was performed by repeating dry mixing and steaming operations until forming a homogenous coating having a thickness of at least 200 microns.

This resulted in coffee granules coated with a 100% crystalline sucrose/fructose (95/5 ratio) coating, having a closed porosity of less than 2%.

17-24 g coated coffee granules were dissolved in 180-250 mL water and exhibit great reconstitution properties in less than 2 minutes.

### Example 12: Coating with a Mix of Solid Crystalline Carbohydrates and a Hydrated Crystalline Compound

Coated coffee granules were produced according to the invention.

In particular, coffee powder was pre-granulated by roller compaction (Alexanderwerk) to form granules having a D[3,2] particle size between 0.8 and 1.6 mm.

The coffee granules were then dry mixed with a mix of micronized crystalline sucrose, dextrose monohydrate and fructose (85/10/5 weight ratio, D90 particle size below 100 microns) to form a thin coating.

The granules comprising thin coating were heated at 65° C., leading to a fast release of the water from the dextrose monohydrate (about 8% wt of water released from dextrose monohydrate) that is triggering bridging of the crystalline mix. This allowed to form a dense coating of crystalline sucrose, dextrose and sucrose.

Stepwise layering coating (pan coating) was performed by repeating dry mixing and heating operations until forming a homogenous coating having a thickness of at least 200 microns.

This resulted in coffee granules coated with a 100% crystalline sucrose/dextrose/fructose (85/10/5 ratio) coating, having a closed porosity of less than 2%.

17-24 g coated coffee granules were dissolved in 180-250 mL water and exhibit great reconstitution properties in less than 2 minutes.

### Example 13: Coating with Solid Amorphous Carbohydrate

Coated coffee granules were produced according to the invention.

In particular, coffee powder was pre-granulated by roller compaction (Alexanderwerk) to form granules having a D[3,2] particle size between 0.8 and 1.6 mm.

The coffee granules were then dry mixed with micronized amorphous sucrose (D90 particle size below 100 μm) to form a thin coating.

The thin coating of granules was humidified and heated simultaneously, by steaming, above the glass transition temperature of the amorphous sucrose allowing carbohydrate particles bridging while simultaneously recrystallising the amorphous sucrose. This allowed to form a dense coating of crystalline sucrose.

Stepwise layering coating (pan coating) was performed by repeating dry mixing and steaming operations until forming a homogenous coating having a thickness of at least 200 microns.

This resulted in coffee granules coated with crystalline sucrose coating, said coating comprising 100% crystalline sucrose and having a closed porosity of less than 2%.

17-24 g coated coffee granules were dissolved in 180-250 mL water and exhibit great reconstitution properties in less than 2 minutes.

### Example 14: Coating with a Mix of Solid Crystalline and Amorphous Carbohydrates

Coated coffee granules were produced according to the invention.

In particular, coffee powder was pre-granulated by roller compaction (Alexanderwerk) to form granules having a D[3,2] particle size between 0.8 and 1.6 mm.

The coffee granules were then dry mixed with a mixture of amorphous and crystalline sucrose (20/80 ratio, D90 particle size of less than 100 microns) to form a thin coating.

The thin coating of granules was then humidified and heated via steaming above the glass transition temperature of the amorphous sucrose to trigger carbohydrate particles bridging while simultaneously allowing recrystallising the amorphous sucrose. This allowed to form a dense coating of crystalline sucrose.

Stepwise layering coating (pan coating) was performed by repeating dry mixing and steaming operations until forming a homogenous coating having a thickness of at least 200 microns.

This resulted in coffee granules coated with crystalline sucrose coating, said coating comprising 100% crystalline sucrose and having a closed porosity of less than 2%.

17-24 g coated coffee granules were dissolved in 180-250 mL water and exhibit great reconstitution properties in less than 2 minutes.

### Example 15: Coffee Granules Coated with Crystalline Lactose Coating

Coated coffee granules were produced according to the invention.

In particular, coffee powder was pre-granulated by roller compaction (Alexanderwerk) to form granules having a D[3,2] particle size between 0.8 and 1.6 mm.

The coffee granules were fluidised in a fluid bed. The coating of the coffee granules was performed by adding micronized crystalline lactose (D90 particle size below 100 μm) in dry with the fluidised coffee granules while simultaneously spraying concentrated lactose solution (40% lactose) at a temperature of 60° C. which dried and crystallised the dissolved lactose directly. The coating was performed until forming a homogenous layer having a thickness of at least 200 microns. This resulted in coffee granules coated with crystalline lactose coating, said coating comprising 100% crystalline lactose and having a closed porosity of less than 2%.

The fluidisation and coating were performed using “GXR” GRANUREX® from Freund Vector.

17-24 g coated coffee granules were dissolved in 180-250 mL water and exhibit great reconstitution properties in less than 2 minutes.

### Example 16: Cocoa Granules Coated with Crystalline Maltose Coating

Coated cocoa granules were produced according to the invention.

In particular, cocoa powder was pre-granulated by roller compaction (Alexanderwerk) to form granules having a D[3,2] particle size between 0.8 and 1.6 mm.

The cocoa granules were fluidised in a fluid bed. The coating of the cocoa granules was performed by adding micronized crystalline maltose (D90 particle size below 100 μm) in dry into the fluidised cocoa granules while simultaneously spraying concentrated maltose solution (45% maltose) at a temperature of 60° C. which dried and crystallised the dissolved maltose directly.

The coating was performed until forming a homogenous layer having a thickness of at least 200 microns. This resulted in cocoa granules coated with crystalline maltose coating, said coating comprising 100% crystalline maltose and having a closed porosity of less than 2%.

The fluidisation and coating were performed using “GXR” GRANUREX© from Freund Vector.

17-24 g coated cocoa granules were dissolved in 180-250 mL water and exhibit great reconstitution properties in less than 2 minutes.

### Example 17: Production of Coated Coffee Granules with Intermediate Hydrophobic Layer

Coated coffee granules were produced according to the invention.

In particular, coffee powder was pre-granulated by roller compaction (Alexanderwerk) to form granules having a D[3,2] particle size between 0.8 and 1.6 mm.

The coffee granules were sprayed with lecithin to form an intermediate hydrophobic layer on the surface of the coffee granules.

After spraying lecithin, the coffee granules were fluidised in a fluid bed. The coating of the coffee granules was performed by adding micronized crystalline sucrose (D90 particle size below 100 μm) in dry with the fluidised coffee granules while simultaneously spraying concentrated sucrose solution (65% sucrose) at a temperature of 60° C. which dried and crystallised the dissolved sucrose directly. The coating was performed until forming a homogenous layer having a thickness of at least 200 microns. This resulted in coffee granules coated with crystalline sucrose coating, said coating comprising 100% crystalline sucrose and having a closed porosity of less than 2%.

The fluidisation and coating were performed using “GXR” GRANUREX® from Freund Vector.

17-24 g coated coffee granules were dissolved in 180-250 mL water and exhibit great reconstitution properties in less than 2 minutes.

### Example 18: Measurement of Water Vapor Transmission Rate (WVTR) of Crystalline Lactose Coating and Crystalline Sucrose Coating

Water Vapor Transmission Rate (WVTR) is usually measured on packaging materials to evaluate their barrier properties. The system consists of an aluminium cup containing dried silica gel in the bottom and a paper on the op sealed with wax on the edges. The set-up will then be placed in a climatic chamber at a defined climate (temperature and relative humidity) and weighted at different time points.

The WVTR of crystalline sucrose coating and crystalline lactose coating was measured in a similar way to assess their barrier properties. To do so, a paper with a very low barrier properties to water was coated with crystalline lactose or sucrose. Then, WVTR was measured on the coated paper based on a system similar to the one used to measure WVTR on packaging materials.

Based on EU regulation, packaging have good barrier properties when WVTR is of 1 g/m²/day or below. Hence, in the present case, the coating is considered to have good barrier properties when the WVTR is of 1 g/m²/day or below.

### Paper Material

To characterize the barrier properties of the coating, a paper with negligible barrier properties was selected to ensure that the WVTR value measured represents the one of the coatings and not the one of the paper. In particular, paper UPM 62 (grammage of 62 g/m²) was selected as it has very low and so negligible barrier properties towards moisture.

Preparation of Paper Coated with Sucrose or Lactose

A sheet of paper UPM 62 was stuck on an aluminium foil with tape on 3 sides to avoid moving of the paper. The paper stuck on aluminium foil was then put on a coater (K Control Coater, RK Printcoat instruments) with the side of the paper with tape facing upwards. The coater was then equipped with a meter bar (coating) n° 5 (wet film of 50 μm). A solution of sucrose (70% TS) or saturated solution of lactose (25% TS) was added with a pipet directly next to the bar and the coating of the paper was performed with the coater until reaching the near end of the page (1-2 cm before the end of the sheet). The addition of sucrose solution or lactose solution was repeated several times during the coating operation to avoid the absence of sucrose on the bar until the end of the coating operation. Once the coating operation was terminated, the paper coated with sucrose or lactose was put in an oven at 100° C. for 5-10 min to obtain a dry crystalline sucrose or lactose coating. The paper coated with crystalline sucrose or crystalline lactose was let to cool down to room temperature. The different steps were repeated until reaching the desired coating thickness.

### Preparation of the WVTR Cup

Four WVTR cups was prepared for each coating thickness: three for measuring the coating barrier and one without silica gel for the blank (measurement of water absorption of paper and coating).

For each coating thickness, four circles of 25 cm² were cut on the paper coated with crystalline sucrose or crystallin lactose. Four small WVTR cups were taken. Three of them were filled with approximatively 10 g/15 ml of silica gel while the last one was the blank and was empty (i.e.e without silica gel). The four cups were covered with the pre-cut crystalline sucrose-coated or lactose-coated paper circles and sealed with melted wax. The wax was then cooled down until solidification to obtain final WVTR pans.

### WVTR Measurements

When the final WVTR pans were ready, they were placed in a climatic chamber at 23° C., 85% RH.

Samples were then weighted up to three times a week for one week.

The experiment was stopped when the weight was increasing at a slower rate or when the silica gel took more than 20% of its initial weight.

Based on the weights measured, the WVTR was calculated with the following equation:

$$WVTR = \frac{Δ {m}_{s} - Δ {m}_{b}}{t * A * 10}$$

Where Δmₛ and Δm_{b} are the weight increase of the sample and blank respectively in mg, t the time in days, A the surface of the coated paper in m² and WVTR the water vapor transmission rate in g/m²/day.

The first weight measured at t=0 day was not considered in the calculation of the WVTR. For the WVTR calculation, the average of the three different measurements was taken.

### Coating Thickness Measurement

To measure the thickness the coatings, the papers coated with crystalline sucrose or crystalline lactose were stored overnight in a controlled environment (23° C., 50% RH). Then, for each sample, the papers coated with crystalline sucrose were cut into four circles of 12.5 cm². After cutting, only papers with intact crystalline sucrose coating were used for the determination of the thickness.

Thereafter, 10 measurements were taken using a caliper to determine the average thickness of the uncoated paper UPM 62 (46.8 am).

Then, the thickness of each of the previously cut coated paper circles was measured around three times with a caliper and the average of all measurements was calculated. The final thickness of the coating was then calculated with the following equation:

CT=TCP−TP

Where CT is the thickness the coating in μm, TCP is the thickness of the coated paper in μm, TP is the thickness of the uncoated paper in μm.

### Results

As shown in FIG. 6, for crystalline sucrose coating, a WVTR of 1 g/m²/day is reached with a coating thickness of 138.5 μm based on the logarithmic trendline. Based on the foregoing, it is expected that good barrier properties are obtained with a thickness of 138.5 μm or above 138.5 μm. When the thickness is below 138.5 μm, it can be observed that the barrier properties of the coating are insufficient as the WVTR is above 1 g/m²/day. Based on those results, it appears that a crystalline sucrose coating of at least 138.5 μm opens the opportunity for storage of food particles, such as powders, in packaging with low barrier properties or even without packaging as the coating provides sufficient barrier properties.

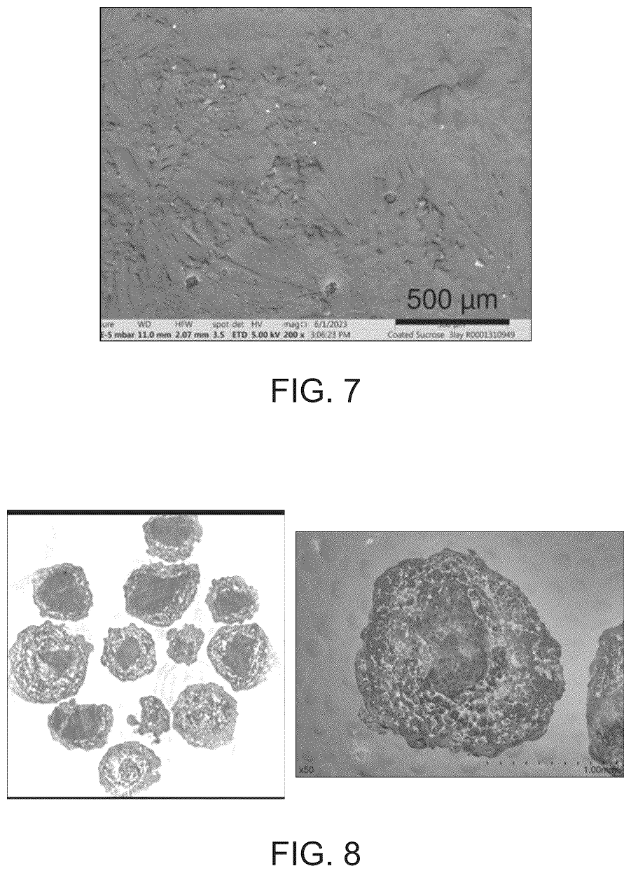

The surface of the crystalline sucrose coating that was applied on the paper was observed by Scanning Electron Microscopy (SEM). It can be observed in FIG. 7 that the surface of the crystalline sucrose coating is homogenous.

### Example 19: Barrier Properties of Heterogeneous Coating

Cocoa powder particles coated with a heterogenous crystalline sucrose coating were provided. By “heterogenous coating”, it is understood a coating layer that does not cover the full surface of the powder and that may comprise different thickness across its surface area.

The coated cocoa powder particles were observed by Scanning Electron Microscopy (SEM).

In addition, the barrier properties of the coated cocoa powder particles were assessed.

In particular, the cocoa powder particles comprise a significant amount of water. Hence, the moisture loss during drying was measured to assess the barrier properties. A significant loss of weight, and so a significant loss of water during the drying step mean that the coating has low barrier properties. The moisture loss was assessed as follows. The coated cocoa powder particles were dried. The weight of the same volume of coated cocoa powder particles was measure before and after drying in aluminium pans. The resulting weight loss relates to the quantity of moisture loss from the sample.

### Results

It was observed that the coated cocoa powder particles have heterogenous crystalline sucrose coating layer that does not cover the full surface (FIG. 8).

In addition, the moisture loss trials show a significant loss of weight, and so a significant loss of moisture after drying. These results tend to show that a heterogenous coating layer has low and unsatisfactory barrier properties.

Although the invention has been described by way of example, it should be appreciated that variations and modifications may be made without departing from the scope of the invention as defined in the claims.

1: A method of making a food composition comprising one or a plurality of coated food particles, the method comprising the steps of:
a) providing one or a plurality of food particles,
b) coating each of the one or plurality of food particles of step a) with a carbohydrate to form the food composition comprising the one or plurality of coated food particles,
the one or plurality of coated food particles are coated with a crystalline carbohydrate layer,
wherein the crystalline carbohydrate layer comprises at least 95% crystalline carbohydrate and has a closed porosity lower than 10%.

2: The method according to claim 1, wherein the carbohydrate in step b) of coating is:
i) at least one solid crystalline carbohydrate, or
ii) a combination of at least one solid crystalline carbohydrate and at least one hydrated crystalline compound, or
iii) at least one solid amorphous carbohydrate, or
iv) a combination of at least one solid crystalline carbohydrate and at least one solid amorphous carbohydrate, or
v) a combination of at least one solid crystalline carbohydrate, and at least one solid amorphous carbohydrate and at least one hydrated crystalline compound, or
vi) a liquid solution or suspension of at least one carbohydrate;
wherein the step biii) comprises, after coating, a step of heat treatment and/or humidification above the glass transition temperature Tg of the solid amorphous carbohydrate to trigger carbohydrate particles bridging and convert amorphous carbohydrate into crystalline carbohydrate, wherein the humidification step is followed by a drying step;
wherein the step biv) optionally comprises, after coating, a step of heat treatment and/or humidification above the glass transition temperature Tg of the solid amorphous carbohydrate to trigger carbohydrate particles bridging and convert amorphous carbohydrate into crystalline carbohydrate, wherein the humidification step is followed by a drying step;
wherein the step by) optionally comprises, after coating a step of heat treatment and/or humidification above the glass transition temperature Tg of the solid amorphous carbohydrate to trigger carbohydrate particles bridging and to convert amorphous carbohydrate into crystalline carbohydrate;
wherein the step bvi) comprises, after coating, a drying step, optionally preceded by a cooling step to convert carbohydrate dissolved in the liquid solution or suspension of at least one carbohydrate into crystalline carbohydrate.

3: The method according to claim 2, wherein the step bi) of coating comprises, after coating, a step of humidification to trigger crystalline carbohydrate particles bridging.

4: The method according to claim 2, wherein the step bii) of coating comprises, after coating, a step of heat treatment to trigger crystalline carbohydrate particles bridging.

5: The method according to claim 1, wherein the carbohydrate in step b) of coating has a D90 particle size at least 5 times lower than the D[3,2] particle size of the one or plurality of food particles.

6: The method according to claim 1, wherein the crystalline carbohydrate layer is a protective barrier.

7: The method according to claim 1, wherein the crystalline carbohydrate layer has a thickness of at least 100 microns.

8: The method according to claim 1, wherein the coating step b) is repeated several times.

9: The method according to claim 1, wherein the crystalline carbohydrate layer comprises at least 98% crystalline carbohydrate.

10: The method according to claim 1, wherein the crystalline carbohydrate layer is lactose and/or sucrose.

11: The method according to claim 1, further comprising a step of applying a hydrophobic layer on the one or plurality of food particles between step a) and step b).

12: The method according to claim 11, wherein the hydrophobic layer comprises fat or lecithin.

13: The method according to claim 1, wherein D[3,2] particle size of the one or plurality of food particles is 0.8 mm to 20 mm.

14: The method according to claim 1, wherein at least 50% of the one or plurality of coated food particles of the food composition do not have any edges with an angle less than 80°.

15: The method according to claim 1, wherein the one or plurality of food particles are one or a plurality of shaped food particles, and wherein the one or plurality of coated food particles are one or a plurality of coated shaped food particles.

16: The method according to claim 15, wherein the one or plurality of shaped food particles are obtained by shaping the one or plurality of food particles using a grinder, milling device, compacter, extruder, pelletizer or spheronizer.

17: The method according to claim 1, wherein the one or plurality of food particles are powder.

18: The method according to claim 1, wherein the food composition is coffee mix, infant formula, food supplement, nutritional composition, powdered beverage, or a moisture sensitive food composition.

19: A coated food particle which comprises a food particle which is coated with a crystalline carbohydrate layer, wherein the crystalline carbohydrate layer comprises at least 95% crystalline carbohydrate and has a closed porosity lower than 10%.

20: A food composition comprising one or a plurality of coated food particles, wherein each of the one or plurality of coated food particles is coated with a crystalline carbohydrate layer, wherein the crystalline carbohydrate layer comprises at least 95% crystalline carbohydrate and has a closed porosity lower than 10%.
